(19) United States
(12) Patent Application Publication
(10) Pub. No.: US 2014/0344172 A1
(43) Pub. Date: Nov. 20, 2014

(54) DATA ANALYTICS PLATFORM USING SOCIAL NETWORK AND WEB DATA TO IDENTIFY A PATTERN OR ANOMALY AMONG RELEVANT EVENTS AND ENTITIES

(71) Applicant: AssistMyCase, Inc., San Francisco, CA (US)

(72) Inventor: M. Jawad ANSARI, San Francisco, CA (US)

(21) Appl. No.: 14/256,901

(22) Filed: Apr. 18, 2014

Related U.S. Application Data
(60) Provisional application No. 61/814,084, filed on Apr. 19, 2013.

(51) Int. Cl. G06Q 10/06; G06Q 50/18; G06Q 50/00

(52) U.S. Cl. CPC G06Q 10/06; G06Q 50/01; G06Q 50/18
USPC 705/311

(57) ABSTRACT

Disclosed is a technique that intakes data from an initial court case and relevant court cases to identify relevant events and entities (e.g. an individual or an organization). The technique generates interrelationships between the entities associated with the event and indicates a time (e.g., the month and year) of the event. The technique uses the identified data (e.g., an event and the associated entities) to further search social network data and Web data to identify additional data relevant to the initial court case. The technique maps the data from the social networks and the Web to determine more accurate interrelationships of relevant entities, events, and locations. From this map, a user can discover one or more patterns or anomalies relevant to the initial court case. For example, a detected anomaly can enable a litigator to focus defense efforts on a specific time frame before the occurrence of the anomaly.

### CROSS-REFERENCE TO RELATED APPLICATION(S)

This patent application claims the benefit of U.S. Provisional Patent Application Ser. No. 61/814,084, filed Apr. 19, 2013, which is incorporated by reference herein in its entirety.

### BACKGROUND

The litigation market (e.g., commercial litigation) has been growing larger over time. Legal cases (e.g., corporate legal cases) can take years to resolve and can prove very expensive, often costing an organization millions of dollars. In addition, legal cases have become more complex with the onset of social networks (also called social media), such as Facebook, Twitter and Google+. For instance, a litigation team can have a team member manually access and study the online presence of an opposing litigator in order to try to gain an advantage.

Currently, a paralegal or an associate on a litigation team can examine documents relating to a case and manually construct a chronology of events and a list of entities involved in the case. To create the chronology or list, the paralegal or the associate can use existing data repository software to construct a case timeline. However, because these efforts are currently user-dependent and manual, they are inadequate. These efforts can introduce human error, can prove unmanageable given the potential of dozens of court filed documents, or can exceed the budget of either of the parties, which can adversely affect the management and/or outcome of the case from the perspective of one or more parties in the case.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates an environment in which using social network data and Web data to identify a pattern or an anomaly of a court case can be implemented.

FIG. 2 illustrates an example report of specific events and entities relevant to a specific court case.

FIG. 3A illustrates an example map of plotted values of social network data versus time, indicating an anomaly of behavior compared to a baseline of behavior.

FIG. 3B illustrates an example map of plotted values of key events and friend additions versus time, indicating a specific pattern of behavior and a preceding hot zone.

FIG. 4 is a schematic diagram of example types of data extracted from each of Twitter, Facebook, and Google Plus.

FIG. 5 is a schematic diagram of the components of the case score.

FIG. 6 illustrates the use of the system for detecting patterns or anomalies within a larger, full services, lending and case monitoring litigation system.

FIG. 7 is a flow diagram of a process within the litigation system of FIG. 6 for determining whether the user is a party to the court case.

FIG. 8 is a process diagram for determining the statute of limitations within the litigation system of FIG. 6.

FIG. 9 is a flow diagram of a process within the litigation system of FIG. 6 for determining the legal claim.

FIG. 10 is a flow diagram of a process within the litigation system of FIG. 6 for profiling the opposing party.

FIG. 11 is a high-level block diagram showing an example of processing system in which at least some operations related to a payment transaction auction can be implemented.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

Introduced here is a technique that automatically applies data analytics to data from public and proprietary data sources. The data is extracted and then organized to graphically present key events and entities referenced in the extracted data. The organized and graphically presented data can be used to identify a pattern or an anomaly inherent in the data. Subsequently, a user can apply the identified pattern or anomaly to identify an area on which to focus efforts (such as litigation related efforts), enabling the user to work more efficiently.

For instance, key events and key entities can be identified in and extracted from documents related to an initial court case and relevant court cases. Then, using the key events data and entities data identified in the initial court case, the technique searches the relevant court cases, social network data and other data publicly available on the World Wide Web (“Web data”) (e.g., an expensive restaurant patronized) to identify additional data relevant to the court case. An example of social network data is data indicating that a Facebook user selected “Like” on a particular post or photograph on a Facebook page to indicate that the user likes that post or photograph. Another example of social network data is data indicating that a Facebook user selected, from the user's mobile device, a “Check-in” status and then a specific location from a list of locations causes the Facebook application to create a post on his page indicating the present, geographical location of the user. These additional data can be added to the key events data and key entities data and the combination of data is used to map interrelationships between the data to identify a pattern or an anomaly. For instance, an identified pattern can be found in a plaintiff's behavior (e.g., the plaintiff started patronizing expensive restaurants and following high-profile individuals on the social network at a significant point in time, e.g., a couple of weeks before filing the court case). A user (e.g., a defense attorney) can use the mapped data to identify and focus on a key interval of time, such as the period of time before the case was filed. In focusing on this interval of time, the user can undermine the plaintiff's case by introducing an uncertainty as indicated by a deviation in the plaintiffs behavior indicated on the map. Specifically, the technique can generate and display on the map a baseline of behavior and the deviation from the baseline. By using information regarding the deviation in behavior, the user can potentially reduce litigation time and cost.

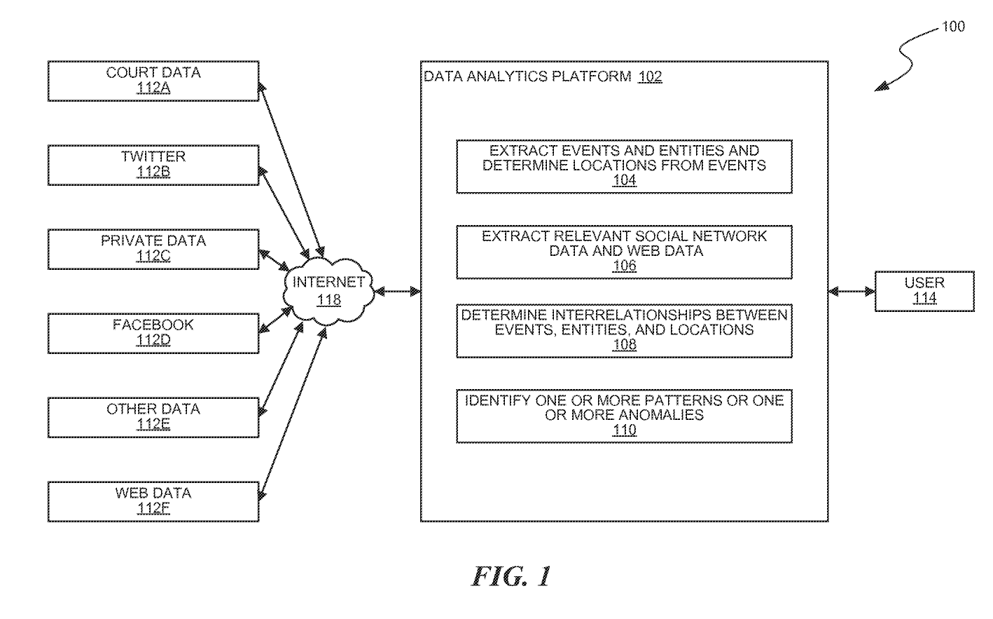

FIG. 1 illustrates an environment in which a data analytics platform can be implemented. The environment includes a plurality of public and proprietary data sources, including court data 112A (e.g., case documents), Twitter (Twitter, San Francisco, Calif.) 112B, private data 112C (e.g., evidentiary documentation, witnesses, and third-party financing), Facebook (Facebook, Palo Alto, Calif.) 112D, other data 112E (e.g. to capture any miscellaneous relevant data such as an uploaded newspaper article), and Web data 112F (e.g., informational data from a Yelp! post (Yelp Inc., San Francisco, Calif.) and background information). Each of the plurality of public and proprietary data sources is in communication with a network 118 (e.g., the Internet), which is in communication with the data analytics platform 102. The data analytics platform 102 is in communication with a user 114.

The data analytics platform 102 includes a component 104 to extract one or more events, one or more entities, and references to time from the court data 112A. An event is a reference to an action verb in an extracted sentence and an entity is a reference to an individual or organization in the extracted sentence. The entity can be part of the event when it is referenced in the same sentence. Time can be a specific instance or a range from when a specific activity started to when the activity ended. The court data can include, for example, arbitration data, financing data, damages data, evidence data, witnesses data, defendant defenses data, jurisdiction data, class action data, court documents (e.g. pleadings and motions), a contract, and amendments data. For example, component 104 can extract a sentence from clause number 55 of a court case and identify that the terms, John Doe, Jane Smith, executives, Lending Company A, and SEC were mentioned in the sentence.

Specifically, the data analytics platform 102 uses a Natural Language Processing (NPL) algorithm to parse documents into sentences. The algorithm then searches for sentences that contains an action verb. For example, in the sentence, John talks at inappropriate times, talks is the action verb. As another example, in the sentence, Jennifer watched the pretty birds building a nest, watched is the action verb. Additionally, the algorithm searches for the subject and the object in the same sentence. In this example, John and Jennifer are identified as entities. The algorithm identifies references of time in the sentence and the surrounding sentences that are associated with the specific event. For example, in the sentence, John and Mary discussed the pertinent details of the patent on Mar. 6, 1988, the element of time identified is Mar. 6, 1988. The data analytics platform 102 stores the extracted information including events, entities, and individuals and organizations who are mentioned in a database.

From this point, the social network and Web extraction component 106 uses the extracted data from component 104 to search social network data and Web data to identify further relevant data. The NPL algorithm identifies the further relevant data by extracting and storing according to the same processes described above regarding extracting events, entities, and time from court data. Specifically, social network and Web extraction component 106 reads the feeds from the social networks and also uses the social network APIs to search for the profiles of the entities that have already been identified. For example, social network and Web extraction component 106 can search publically available social network data to identify Likes and Check-in by John Doe and Jane Smith. As well, social network and Web extraction component 106 can search the Web data to identify that John Doe commented for the first time on a blog for high-end cars. As another example, social network and Web extraction component 106 can search the Web data to perform a background check on a specific individual (e.g., John Doe).

The data analytics platform 102 includes a component 108 that determines, in response to identifying the relevant social network data and Web data, interrelationships between the events, entities, social network data, and Web data. Because the data analytics platform 102 already extracted the element of time from the case document, the platform 102 can then analyze (e.g., organize and plot) the information from the social networks to identify inconsistencies. For example, John alleges that he met Mary in June 2010 in Los Angeles. However, he has a tweet or a Check-in approximately at the same time from London. This inconsistency identified by the data analytics platform 102 can be employed by the user (e.g., the litigator) to cause a shadow of doubt in the minds of the jury.

In another example, interrelationships determining component 108 presents a map in graph format of the Likes and Check-in of John Doe over a timeline of litigation, including the time prior to the filing of the court case. Component 110 of the data analytics platform 102 uses the map data to identify a pattern or an anomaly indicative of John Doe's behavior. For instance, component 110 can automatically generate a report containing data indicating a direction of change from John Doe's baseline of Likes and Check-ins to more expensive Checked-in places and more expensive Liked retails stores. As well, the report can indicate a time when the change occurred. In another example, the user 114 views an output graph and determine for himself or herself when the change in the behavior trend occurred.

The data analytics platform 102 automatically and periodically checks the court data source 112A for new court data regarding the court case. When new court data is available, the data analytics platform 102 automatically and in real-time repeats the process from performing data extraction to identifying a pattern or anomaly. Examples of new court data are new case developments and new case filings.

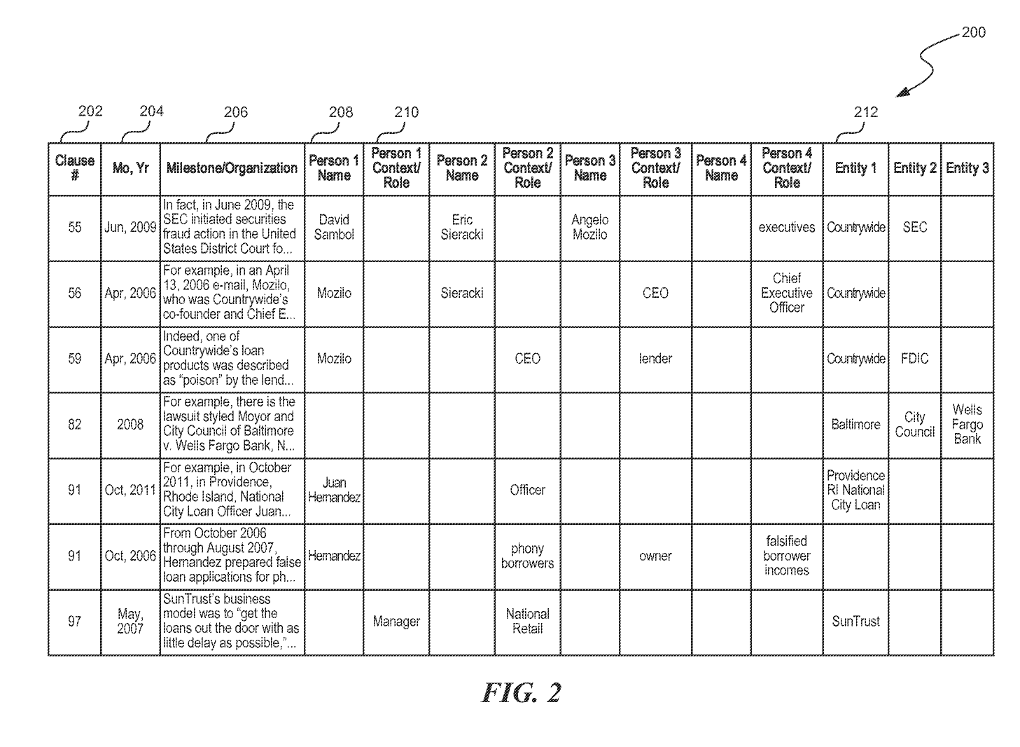

An example of a report 200 produced by the extraction component 104 is shown in FIG. 2. Each row reflects a specific extracted sentence of data. The first column 202 indicates which clause is referenced regarding the specific extracted sentence. For example, for the first row, the clause number is 55. The second column 204 indicates the month and year assigned to the extracted sentence. For this row, the month is June and the year is 2008. The third column 206 contains a part of the extracted sentence. Specifically, the extracted data is a portion of a sentence found in clause number 55. The remaining columns contain names of individuals and organizations and other relevant metadata referenced in the text in column 206. For example, column 208 contains the name David Sambol. Column 210 contains the context (e.g. location) or role that component 104 determined to be associated with David Sambol. Here, the entry is blank because no context or role was determined. Column 212 contains the name of a lending institution, Countrywide, because Countrywide is referenced in the extracted text 206 and is determined to be relevant by the extraction component 104.

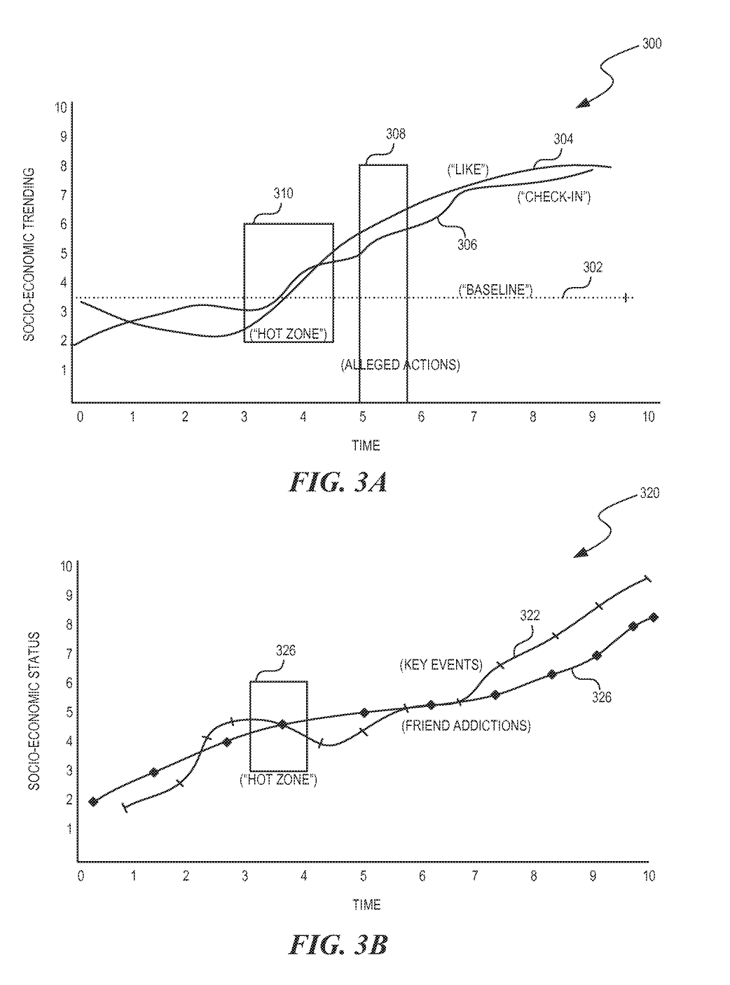

An example output 300 of interrelationship determining component 108 is shown in FIG. 3A. Data points of social network data (e.g., Likes 304 and Check-ins) 306 are plotted based on quantified socio-economic values over a timeline of the relevant court case. The quantified socio-economic value is determined based on predetermined socio-economic ranges representing an increasing or decreasing scale of wealth, power, and influence. Based on having performed an analysis of the underlying data, component 108 determines and draws a baseline 302 of behavior on the social network for this specific entity. Having determined a baseline of behavior, component 108 can determine and graphically indicate a time interval (e.g. a hot zone 310) at which the behavior of the entity noticeably changes. The user 114 can also visually detect by glancing at the graph 300 that the socio-economic behavioral trend of the entity is increasing to a higher level of socio-economic activity. Additionally, a user can overlay the area of alleged actions 308 by the entity to aid the user in the preparation of litigation.

FIG. 3B illustrates another example output 320 of interrelationship determining component 108. Data points of social network data including key events 322 and friend additions 324 are plotted based on quantified socio-economic values over a timeline of the relevant court case. Based on an analysis of the underlying data, component 108 determines and graphically indicates a time interval 326 (e.g. a hot zone 310) centered at 3.5, when the behavior of the entity can be important to the user 114. The user 114 can also visually detect at a glance at the graph 320 that the socio-economic behavioral trend of the entity indicates an increase in the level of socio-economic activity.

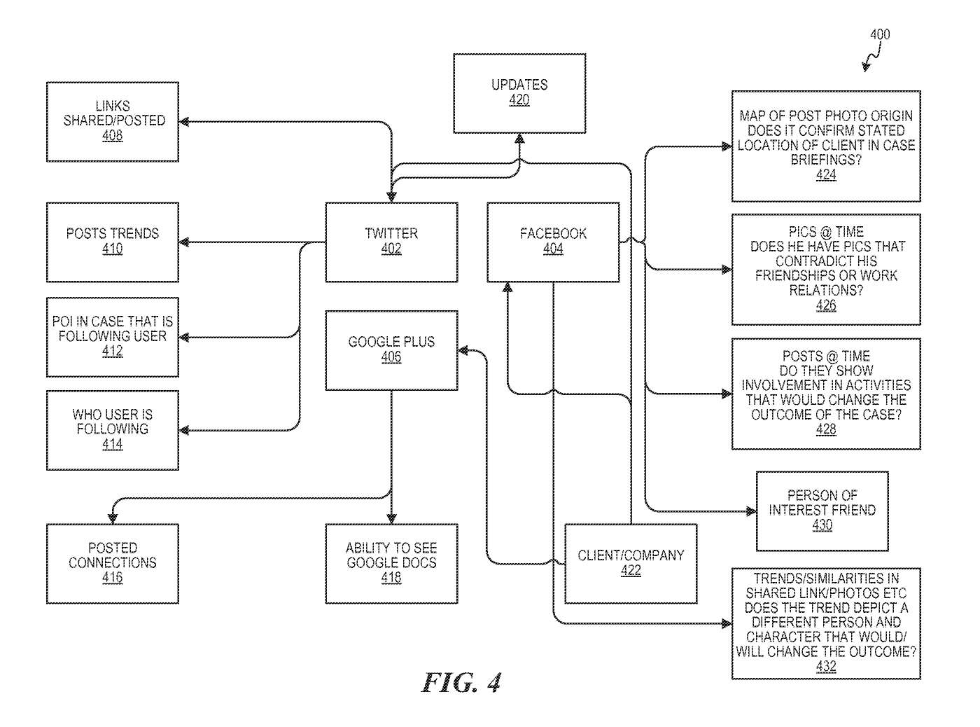

Some examples of social network data and, in some cases, their interrelationships 400 that are publically available and that are used by the data analytics platform 102 are illustrated in FIG. 4. Three example social network accounts are listed, namely, Twitter 402, Facebook 404, and Google+ (Google, Mountain View, Calif.) 406. Each social network account has data coming in (e.g., another account can post to this account) as well as going out (e.g., this account can post to another account). For instance, a user of the Twitter account 402 can output data indicating: the links that are shared or posted 408 by the user, a trend of the types of posts 410, that a person of interest in the court case is following the user 412, and who the user is following 414. Input data into the Twitter account 402 can include updates 420, shared or posted links 408, and posts from a client or company 422.

A user of the Facebook account 404 can output data including a map of the origin of a posted photograph 424 and the data analytics platform 102 can determine whether the map confirms that stated location of a client referenced in the court case briefings. Similarly, the user of the Facebook account 404 can output data including photos indicating a specific time 426 and the data analytics platform 102 can determine whether the photographs contradicts the user's relations with one or more individuals in the photograph (e.g. whether they are friends or colleagues). The user's Facebook account posts at a specific time can show the user's involvement in activities 428 that can potentially change the outcome of the court case. Another type of information that can be collected from the Facebook account 404 is information regarding a friend 430 (e.g. person of interest) of the user. The Facebook account 404 can be used by the data analytics platform 102 to identify a trend or similarity in shared information (e.g., links or photographs) and to determine whether the trend or similarity depicts a different type of person (e.g., character) that could change the outcome of the court case. An example of useful input information to the Facebook account 404 can be or include client or company information 422, for example, information regarding the user's client or company for which the user works.

The user of the Google+ account 406 can post connections 416 or publicly available documents on Google Docs (Google, Mountain View, Calif.) 418. The data input to the Google+ account 406 is or can include client or company information 422.

Some examples of Web data regarding the court case include: blogs, news, geographical points of interest, publicly available profiles of friends, relatives and colleagues of one or more parties of the court case, and political, operational, and financial information.

In addition to the data analytics platform 102 analyzing the data to identify a pattern or an anomaly for a specific entity or event, the data analytics platform 102 can analyze the data to compute a score that quantifies specific aspects of the data. For example, in the context of litigating a court case, the data analytics platform 102 can compute a court case score 512 that a litigation team can use to help decide whether to represent a party of the court case. For instance, a litigation team can decide not to accept a specific case because the associated score was too low

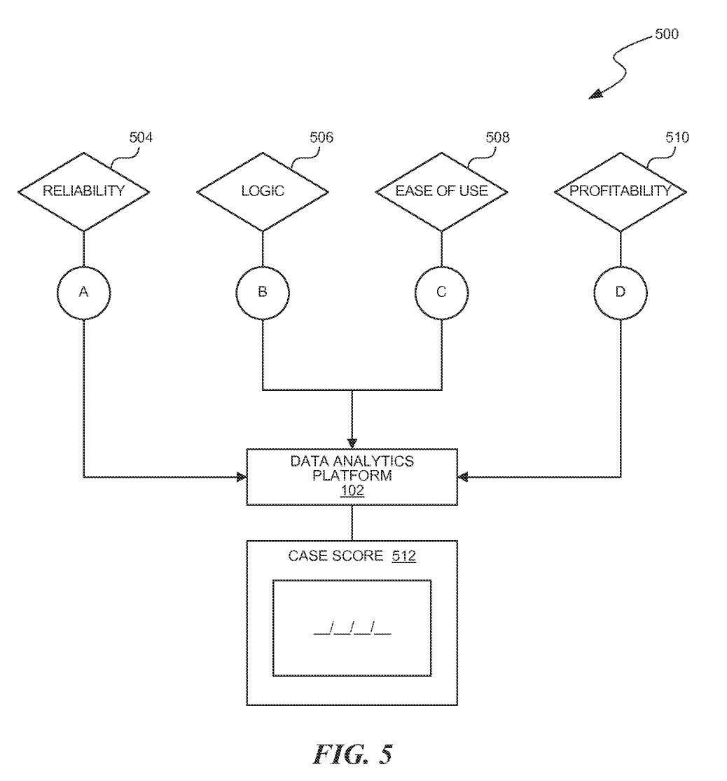

An example of generating a score is shown in FIG. 5. In the example, four types of information are input into the data analytics platform 102 and the information are used to generate the score. The four types of information are reliability data 504, logic data 506, ease of use data 508, and profitability data 510. Additional types of information such as the presence of third party financing and the presence of witnesses (not shown) can also be used to generate the score. For instance, the presence of third party financing and the presence of witnesses can increase the score. The reliability data 504 indicate a measure of the reliability of the resulting data from applying the analytics platform 102 to the input data, including social network data and Web data. For example, a person of interest (e.g. Jane Smith) can cause the score to be low because she has no Facebook account and thus no Facebook friends. When the social network presence is small, the data relying on the associated social network can be insignificant. The logic data 506 are or can include one or more contracts involved in the dispute. For example, the logic data 506 can indicate how logical the case is from a litigating point of view and how logically are the issues of the case. The ease of use data 508 indicate an amount of data. For instance, when the case is relatively new, there is much less data available to the data analytics platform 102 than when the case has been filed for more time (e.g., a year). Thus, when the case is new, the ease of use data 508 can cause the court case score 512 to be low to influence the litigation team not to take the case, as the case might otherwise be very time consuming. The profitability data 510 indicate the size of the funds available to the opposing side. For example, when the opposing side represents wealthy individuals, the cost of litigating against the opposing side could be very high because the opposing side is not trying to keep costs down. Thus, the profitability data 510 indicating that the opposing side has large funds can cause the court case score 512 to be low to indicate to the litigating team that the court case can be too costly. Alternatively, the court case score can be a concatenation of component scores, each component score indicating a score for its type of data. For instance, court case score 512 can include a reliability score of 30, a logic score of 20, an ease of use score of 25 and a profitability score of 25. Further, each of the component scores can be assigned a weight. For instance, the profitability score can be given a weight higher than the other component scores, causing the data analytics platform to inflate the profit score by a specific percentage and deflate the remaining component scores by another or the same percentage.

The data analytics platform 102 can be used in contexts other than litigation. For example, the data sources can reflect other data rather than court related data. For instance, in the context of company acquisitions, the data sources can be or include corporate documents, contracts, organizations involved and so on. Events and entities can be extracted from such data and social network and Web data can be searched for relevant information as in the litigation context. As well, one or more patterns or anomalies can be identified by the data analytics platform 102. Other contexts in which to generate and apply the score include the credit industry (e.g., generate and apply a credit score), the car industry (e.g., generate and apply a score for a specific car), and the medical profession (e.g., generate and apply a score for the matching medical school students with residency programs).

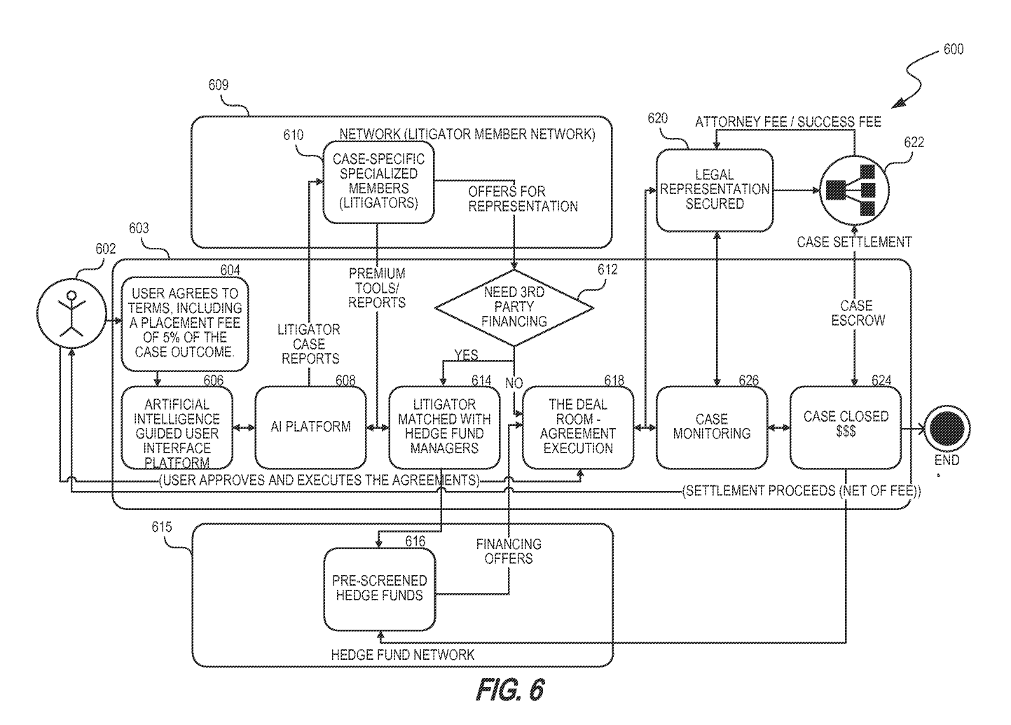

In the context of litigation, the data analytics platform 102 can be incorporated into a full service litigation platform which can include litigation underwriting, financing and placement. FIG. 6 illustrates an embodiment of a full service litigation platform 600. In the illustrated embodiment, a user 602 registers 604 with a full service litigation system 603 of the a full service litigation platform 600. For example, the user 602 can agree to specific terms including a placement fee of a specific percent (e.g., five percent) of the case outcome. The user is directed to a user interface platform 605, for example an artificial intelligence guided user interface platform that guides the user to enter data in a specific sequence or format. The user interface platform 605 is in communication with the data analytics platform 608 that is configured to interact with the artificial intelligence guided user interface platform 606. As described above, the data analytics platform 608 is configured to intake data from the described data sources and identify one or more patterns or anomalies 110. Alternatively, the data analytics platform 608 is further configured to compute and output a court case score 512. In this embodiment, the data analytics platform 608 reports data including the one or more patterns or anomalies 110 and the court case 512 score to one or more members 610 of a litigation network 609 that have subject matter knowledge or expertise regarding details of the case. FIG. 6 illustrates a design feature by which the data analytics platform 608 is configured to send premium reports or provide premium tools to the litigation network, possibly for a price or for another form of compensation.

When a member 610 presents an offer to the full service litigation system 603, the full service litigation system 603 is configured to request from the member 610 whether the member 610 would like third party financing 612. When the member 610 responds affirmatively, the full service litigation system 603 matches the member 610 with a hedge fund manager 614 who has access to a pre-screened hedge fund 616 on a hedge fund network 615. The full service litigation system 603 enables hedge funds managers to provide guidelines as to what type of legal matters that they would like to fund, in what jurisdiction, and up to what amount. For instance, when there is a gap between the amount that the user is willing to pay and the amount the litigator is seeking, and both the user and litigator are open to third party financing, then the full service litigation system 603 enables the hedge funds the opportunity to make up the difference. Alternatively, the hedge funds managers can offer a new proposal which would then have to be reviewed and approved by both the litigator and the user. When the hedge fund 616 is agreed upon, information regarding the hedge fund 616 is sent to an agreement and execution component 618 to close the representation deal. When the member 610 responds negatively, the full service litigation system 603 sends the offer for representation to the agreement and execution component 618 to close the representation deal.

The agreement and execution component 618 matches the amount of dollars that the user (e.g., the client) is willing to pay or the terms upon which the user is willing to retain legal representation. If these financial amounts, including out-of-pocket costs and the scope of the engagement matches an offer by a legal representative, then a match is made between the user and the legal representative. When there are multiple matches, the user is informed of (e.g. presented with) these multiple matches and can decide on the optimal firm to select to provide legal representation.

Once the deal is closed, legal representation is secured 620, whereby the legal representative can collect attorney fees and success fees resulting from the case settlement 622.

The full service litigation system 603 is configured to enable the user to monitor the case 626 at any point in time during the pendency of the case and to view the closing case information (e.g., any paid money).

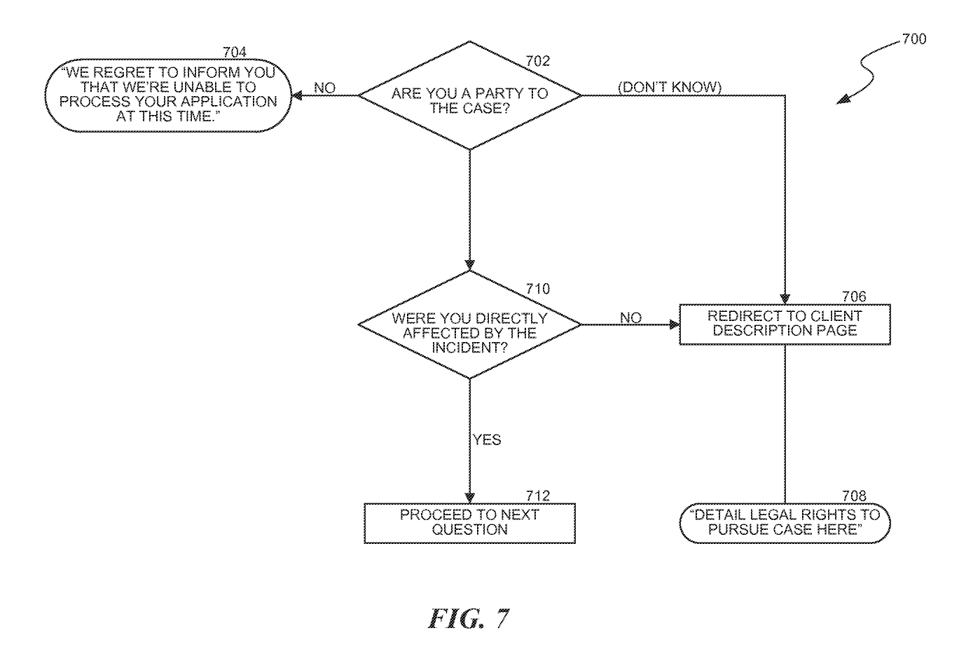

In some embodiments, the data analytics platform 608 is configured to determine whether the user is a party to the court case. An example of such a workflow is shown in FIG. 7. The data analytics platform 608 requests the user to indicate whether the user is a party to the case 702. When the user responds no, the user can proceed no further 704 and is informed so. When the user responds yes, the data analytics platform 608 is configured to ask further questions of the user, if appropriate. For example, the data analytics platform 608 inquires whether the user was directly affected by the incident 710 and if the answer is yes, the user can proceed to the next question 712. When the user responds that he or she does not know, the user is redirected to an appropriate place at which the user can get guided assistance 708. For example, the user can be directed to a client description page. Additionally, the user can then be directed to a page that details relevant legal information 708. For example, the user can be directed to a page that details legal rights to pursue a case.

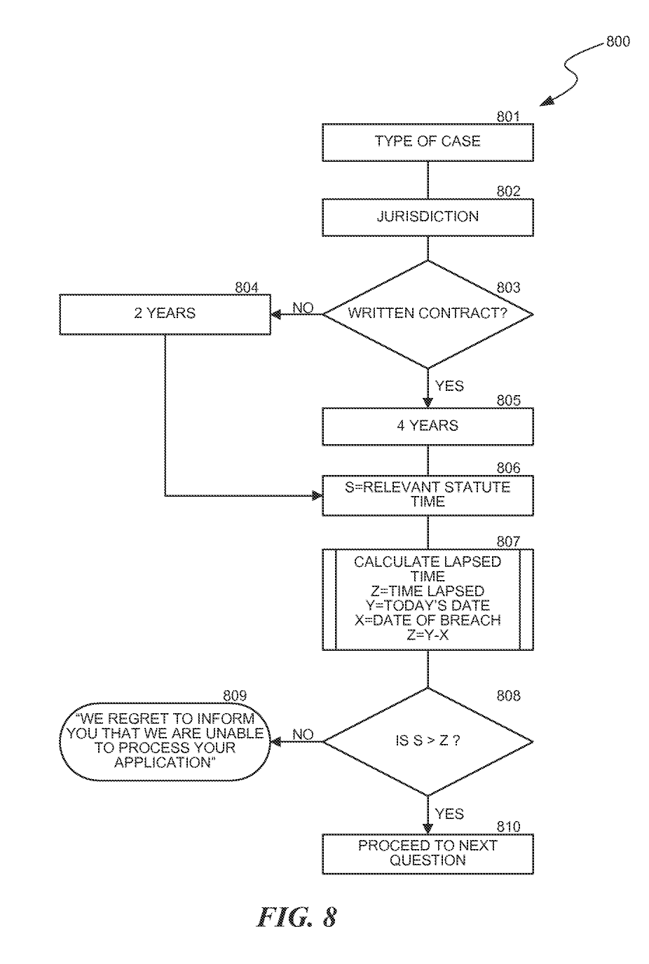

Once the data analytics platform 608 determines that the user is a party to the case, the data analytics platform 608 determines the statute of limitations 800. In the illustrative embodiment of FIG. 8, the type of case is determined 802 and the jurisdiction is determined 802. The question whether there is a written contract 803 is presented to the user. When there is no written contract, the relevant statute time is determined to be two years 804. When there is a written contract, the relevant statute time is determined to be four years 805. A parameter, S, is set to the relevant statute time 806. In addition, the time lapsed, Z, is determined 807. For example, the time lapsed can be computed as the date minus the date of the breach. Then the data analytics platform 608 computes whether the relevant statute is greater than the time lapsed (both in years) 808. When the outcome of this determination is true, the user can proceed to the next step 810. When the outcome of this determination is false, the user cannot proceed any further 809.

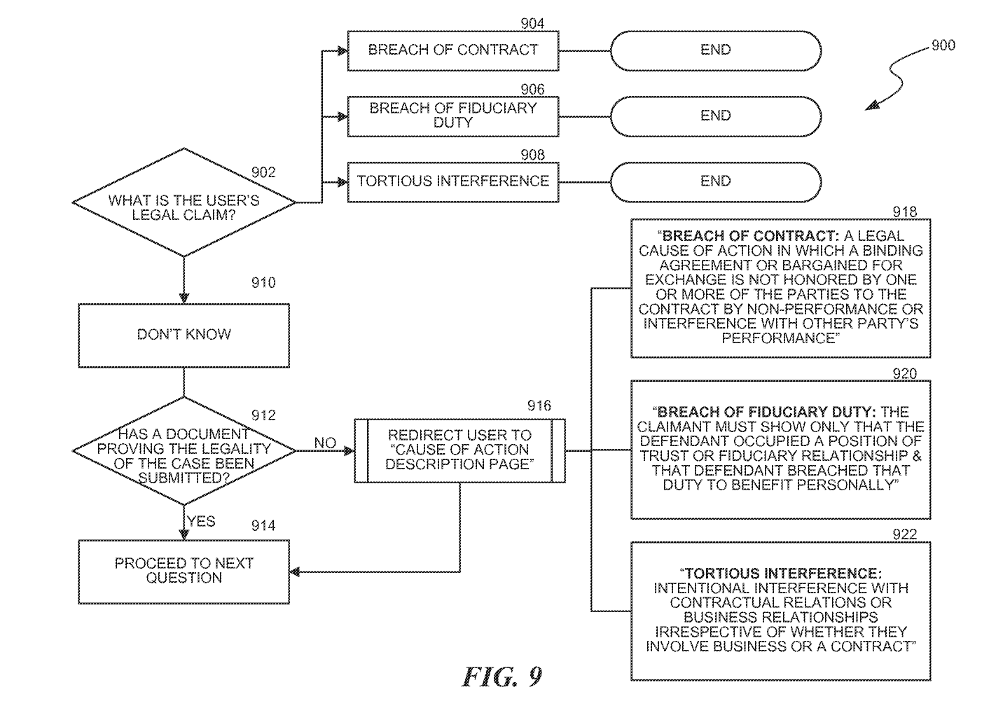

The data analytics platform 608 is further configured to determine additional legal information. For instance, the data analytics platform 608 can be configured to determine the legal claim 900, as illustrated in FIG. 9. In the illustration, the user is asked whether what the legal claim 902 is and then is presented with a list of choices, namely, breach of contract 904, breach of fiduciary duty 906, or tortious interference 908. When the user indicates the legal claim is any of breach of contract 904, breach of fiduciary duty 906, or tortious interference 908, the process ends. Otherwise the data analytics platform 608 proceeds as if the user does not know the legal claim 910. For example, the user can be asked whether a document proving the legality of the case has been submitted 912. When the user answers yes, the user can proceed to the next step 914. When the user answers no, the data analytics platform 608 redirects the user to a location to obtain help (e.g., to a cause of action description page) 916. For instance, at the cause of action description page 916, the user can read the definition of breach of contract 918, the definition of breach of fiduciary duty 920, and the definition of tortious interference 922.

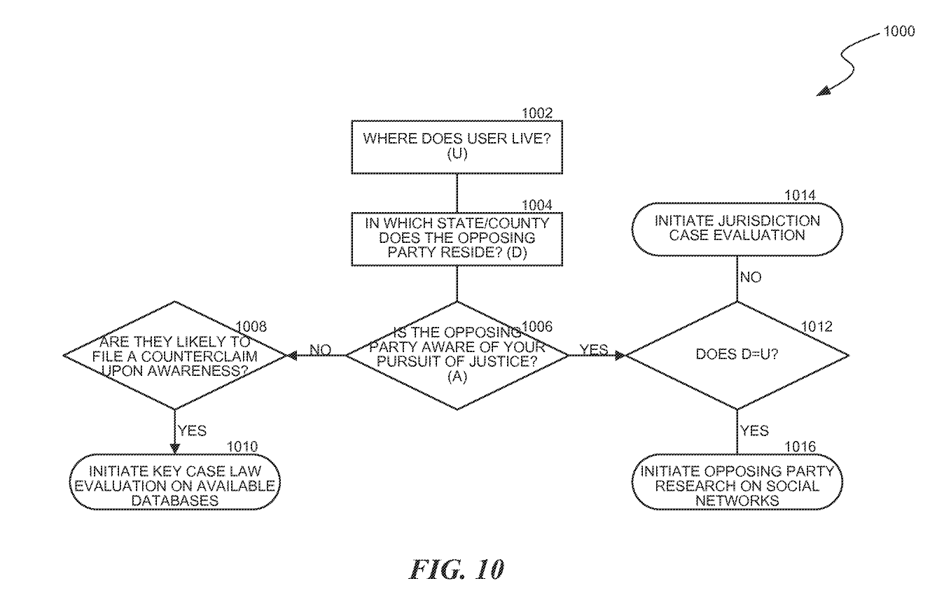

The data analytics platform 608 can be configured to determine in which jurisdiction the court case should reside (not shown). Also, the data analytics platform 608 can be configured to profile the opposing party 1000, as depicted in FIG. 10. The data analytics platform 608 begins the process by asking where the user lives 1002. The data analytics platform 608 guides the user by next asking in which state or county does the opposing party reside 1004. The user is then asked whether the opposing party is aware of the user's pursuit of justice 1006. When the user answers no, the user is further asked whether the opposing party (e.g., defense) is likely to file a counterclaim upon awareness 1008. When yes, the data analytics platform 608 is directed to available key case law evaluation systems and databases 1010. Key case law evaluation systems and databases 1010 extracts and stores data, under the cases cited in the court documents, as described above and then extracts and stores data under similar cases to identify one or more patterns. When the answer is yes, the user is asked whether he or she is the defendant 1012. When no, the data analytics platform 608 is directed to initiate jurisdiction case evaluation 1014. Jurisdiction case evaluation 1014 extracts and stores data, regarding jurisdictions cited in the court documents, as described above and then extracts and stores data regarding jurisdictions cited in similar cases to identify one or more patterns. When yes, the data analytics platform 608 initiates opposing party research on social network data and Web data 106.

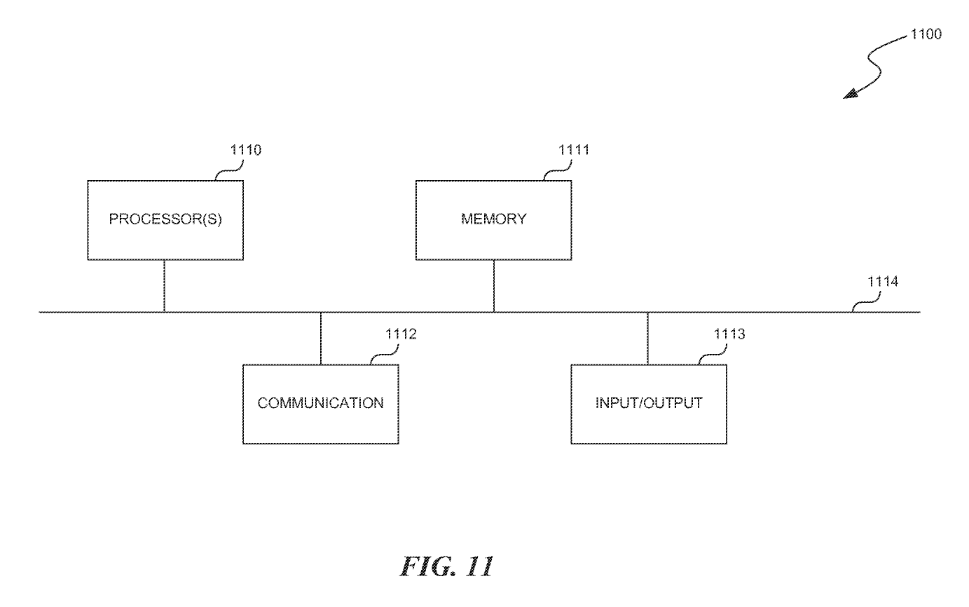

FIG. 11 is a high-level block diagram showing an example of a processing device 800 that can represent or include any of the components described above, such as the system 102, extraction component 104 or 106, interrelationship determining component 108, pattern or anomaly identification component 110, or the determining score.

In the illustrated embodiment, the processing system 1100 includes one or more processors 1110, memory 1111, a communication device 1112, and one or more input/output (I/O) devices 1113, all coupled to each other through an interconnect 1114. The interconnect 1114 may be or include one or more conductive traces, buses, point-to-point connections, controllers, adapters and/or other conventional connection devices. The processor(s) 1110 may be or include, for example, one or more general-purpose programmable microprocessors, microcontrollers, application specific integrated circuits (ASICs), programmable gate arrays, or the like, or a combination of such devices. The processor(s) 1110 control the overall operation of the processing device 1100. Memory 1111 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 1111 may store data and instructions that configure the processor(s) 1110 to execute operations in accordance with the techniques described above. The communication device 1112 may be or include, for example, an Ethernet adapter, cable modem, Wi-Fi adapter, cellular transceiver, Bluetooth transceiver, or the like, or a combination thereof. Depending on the specific nature and purpose of the processing device 1100, the I/O devices 1113 can include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
receiving, at a computer system, court data associated with a court case and social networking data relevant to the court case from one or more data sources;
parsing, at the computer system, the received court data to identify key events, individuals, or organizations referenced in the court data;
using, at the computer system, the identified key events, individuals, and organizations to parse the social networking data to identify a relevant social networking action; and
correlating, at the computer system, the identified relevant social networking action with time to identify a behavioral pattern or an anomaly.

2. A method as recited in claim 1, wherein said one or more data sources comprise a court-related entity, a social networking entity, and a private source of one or more parties to the court case.

3. A method as recited in claim 1, wherein said received data comprise any of: arbitration data; financing data; damages data; evidence data; witnesses data; defendant defenses data; jurisdiction data; class action data; court documents; a contract; and amendments data.

4. A method as recited in claim 1, further comprising, when new court data regarding the court case is available, automatically receiving and parsing the new court data in real-time to identify any new key events, individuals, or organizations to use to parse the social networking data to identify a new relevant social networking action and to correlate the new identified relevant social networking action with time.

5. A method as recited in claim 1, wherein identifying the relevant social networking action comprises searching: shared or posted links; posted trends; person of interest in the court case that is following a user; who the user is following; posted connections; online documents; company of a litigator's client of the court case; whether a map of an origin of a posted photograph confirms a stated location of a litigator's client of the court case; whether a posted photograph at a particular time indicates a contradiction of friendships or work relations of a party of the court case; persons of interest in the court case; or whether trends or similarities in shared posts depict a different person or character causing a change in an outcome of the court case.

6. A method as recited in claim 5, further comprising:
using any of the search results to search on Web data regarding the court case, wherein said data comprise: blogs; news; geographical points of interest; publicly available profiles of friends, relatives and colleagues of one or more parties of the court case; and political, operational, and financial information.

7. A method as recited in claim 1, further comprising:
in response to identifying a behavior pattern or an anomaly, computing a case score by combining generated weighted component scores comprising: a reliability score that indicates reliabilities of individuals of the court case; a logic score that indicates complexity of logistics of the court case; an ease of use score that measures an amount of and usefulness of information resulting from the searches; and a profitability score that measures funds available to an opposing side in the court case.

8. A method as recited in claim 7, further comprising:
reporting the case score and the identified behavioral pattern or the anomaly to a legal representative;
enabling the legal representative to offer legal representation for the court case;
receiving an indication of the legal representative being selected; and
securing an agreement execution between the user and the selected legal representative.

9. A method as recited in claim 1, further comprising enabling the user to monitor the court case.

10. A method as recited in claim 1, further comprising:
matching a legal representative with a hedge fund manager; and
enabling the matched legal representative to accept a financing offer from the matched hedge fund manager to proceed with providing legal representation regarding the court case.

11. A system comprising:
a processor;
a memory coupled to the processor and storing an data analytics module executable by the processor to cause the system to:
receive data regarding a particular matter and social networking data relevant to the matter from one or more data sources;
parse the received data to identify key events, individuals, and organizations referenced in the data;
use the identified key events, individuals, and organizations to parse the social networking data to identify a relevant social networking action; and
correlate the identified relevant social networking action with time to identify a behavioral pattern or an anomaly.

12. A system as recited in claim 11, wherein the particular matter is a court case.

13. A system as recited in claim 11, wherein the data analytics module is further configured to, when new data regarding the particular matter is available, automatically receive and parse the new data in real-time to identify any new key events, individuals, or organizations to use to parse the social networking data to identify a new relevant social networking action and to correlate the new identified relevant social networking action with time to identify a new behavioral pattern or a new anomaly.

14. A system as recited in claim 11, wherein the data analytics module is further configured to, for identifying the relevant social networking action, search: shared or posted links; posted trends; person of interest in the particular matter that is following the user; who the user is following; posted connections; online documents; company of a client of the particular matter; whether a map of an origin of a posted photograph confirms a stated location of a client of the particular matter; whether a posted photograph at a particular time indicates a contradiction of friendships or work relations of an individual of the particular matter; persons of interest associated with the particular matter; or whether trends or similarities in shared posts depict a different person or character causing a change in an outcome of the particular matter.

15. A system as recited in claim 14, wherein the data analytics module is further configured to use any of the search results to search on the Web data regarding the particular matter, wherein said data comprise: blogs; news; geographical points of interest; publicly available profiles of friends, relatives and colleagues of one or more individuals associated with the particular matter; and political, operational, and financial information.

16. A system as recited in claim 11, wherein the data analytics module is further configured to compute a score for the particular matter by combining generated weighted component scores comprising: a reliability score that indicates reliabilities of individuals associated with the particular matter; a logic score that indicates complexity of logistics regarding the particular matter; an ease of use score that measures an amount of and usefulness of information resulting from the searches; and a profitability score that measures funds available to particular persons of interest associated with the particular matter.

17. A method comprising:
acquiring, at a computer system, data, including one or more court documents, from a plurality of publicly available data sources; and
analyzing, by the computer system, the data to detect a pattern or anomaly among one or more events and one or more entities referenced in the data sources.

18. A method as recited in claim 17, wherein data sources comprise social network data and Web data, further comprising:
adding social network data and Web data to the acquired data; and
wherein automatically analyzing the data further comprises mapping interrelationships of relevant events and entities.

19. A method as recited in claim 17, further comprising:
extracting, by a natural language processing algorithm in the computer system, the one or more events and the one or more entities from the data by extracting one or more sentences that contain the one or more events;
for each event:
identifying one or more entities associated with the event; and
identifying a time of the event; and
for each entity:
identifying a role and a location.

20. A method as recited in claim 17, wherein the court documents comprise an initial court case or a relevant court case to the initial court case.

21. A method as recited in claim 17, wherein each of the one or more events and the one or more entities is referenced by document number and clause number of the one or more court documents.

22. A method as recited in claim 17, wherein the one or more entities comprise individuals and organizations.

23. A method as recited in claim 17, further comprising:
updating acquiring and automatically analyzing the data periodically to capture updated data in the court documents, the data indicating new case developments and new case filings.

24. A system comprising:
a processor;
a memory coupled to the processor and storing an data analytics module executable by the processor to cause the system to:
receive data from a plurality of data sources including social network data or Web data;
extract an event or an entity from one of the data sources;
using the extracted event or entity, extract relevant social network data or relevant Web data;
determine an interrelationship between the extracted event or the extracted entity and the extracted relevant social network data or the relevant Web data; and
identify a pattern or an anomaly from the interrelationship.

25. A system as recited in claim 24, wherein the data analytics module further causes the system to:
periodically check the plurality of data sources for updates and receive and process the updated data to identify an updated pattern or an updated anomaly.
